(19) United States
(12) Patent Application Publication
(10) Pub. No.: US 2004/0015401 A1
(43) Pub. Date: Jan. 22, 2004

(54) Systems and methods for distributing template-based multimedia presentations over a network

(76) Inventors: In Lee, Atlanta, GA (US); David Pollock, Atlanta, GA (US); Justin Lee, Marietta, GA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/406,474

(22) Filed: Apr. 3, 2003

Related U.S. Application Data
(63) Continuation-in-part of application No. 09/780,020, filed on Feb. 8, 2001.

(51) Int. Cl. G06F 17/60

(52) U.S. Cl. 705/16

(57) ABSTRACT

A plurality of multimedia presentations and a scheduling file may be stored on a display system. In response to reading the scheduling file, the display system determines which multimedia presentations to play at specific times. Periodically, updated scheduling files and updated multimedia presentations may be downloaded from a remote server. Template-based multimedia presentations comprise a template file, a template parts list and media content files. Template files define an arrangement and presentation of selected content element types. A template parts list associates content element types with content elements stored in the media content files. The display system processes template files according to the schedule. In processing a template file, the template parts list is referenced to identify which of content elements are associated with the selected content element types and to retrieve the identified content elements from the corresponding media content files in order to build the multimedia presentation.

### RELATED APPLICATIONS

The present application is a continuation-in-part of U.S. application Ser. No. 09/780,020 filed Feb. 8, 2001, which is hereby incorporated by reference as if set forth fully herein

### TECHNICAL FIELD

The present invention relates generally to methods and systems for distributing multimedia presentations over a network and for scheduling and updating such presentations, and/or portions of such presentations.

### BACKGROUND OF THE INVENTION

With advances in display technology, digital signage systems have become increasingly sophisticated. No longer restricted to static cardboard displays, digital signs are capable of displaying multimedia presentations that more effectively gain consumer attention. These multimedia presentations may include text, graphics, audio and full motion video.

Digital signage systems have been implemented in a network configuration in which each individual display system has access to a central server that contains multiple presentations and that pushes presentation files to each system. Any changes to the presentations or their scheduling must be generated by an operator at the central server. An example of such a system is disclosed U.S. Pat. No. 6,038,545.

### SUMMARY OF THE INVENTION

The present invention provides improved systems and methods for distributing digital multimedia presentations over a network. Systems and methods are provided for facilitating the display of multimedia presentations at a plurality of displays. A plurality of multimedia presentations are stored at a display system. A scheduling file defines a schedule according to which selected multimedia presentations are to be displayed by the display system on selected displays. In response to determining the schedule from the scheduling file, the display system displays the selected multimedia presentations on the selected displays according to the schedule.

In accordance with certain aspects of the invention, template-based multi-media presentations are distributed to the display systems for presentation on one or more displays. A template file defining an arrangement and presentation of selected content element types within the multimedia presentation may be created. The template file may further define the arrangement and presentation of selected content elements. The template file may be configured to reference a template parts list. The template parts list associates the selected content element types with corresponding content elements stored in media content files. The template file, the template parts list and the media content files may be made available to a display system configured to drive one or more displays. The display system executes a stub projector configured to process the template file, wherein the template file references the template parts list in order to identify which of the content elements are associated with the selected content element types and to retrieve said identified content elements from the corresponding media content files in order to build the multimedia presentation.

Multiple template files may be created, each referencing a corresponding template parts list. A scheduling file may also be created to define a schedule according to which the display system is to process selected ones of said template files in order to build corresponding multimedia presentations for display on selected ones of said displays. The scheduling file may be made available to the display system. The stub projector executed by the display system may be configured to read the scheduling file to determine which of the template files to process according to the schedule.

In accordance with other aspects of the invention, template files, template parts list and media content files may be transmitted from a content administrator site to a distribution server via a network for storage. Display system may accesses the distribution server via the network in order to request download of selected template files, template parts lists and media content files.

At the distribution server, a network communication device receives from the content administrator via the network a plurality of template files, a plurality of template parts lists, a plurality of media content files storing media content elements, and a plurality of scheduling files. Each template file defines an arrangement and presentation of selected content element types and is configured to reference a selected template parts list that associates the selected content element types with corresponding content elements. Each scheduling file indicates a schedule according to which a display system is to process selected ones of the template files. The distribution server includes a memory storage for storing the template files, the template parts lists, the media content files and the scheduling files. A processor executes computer-executable instructions for responding to a download request from a requesting display system by transmitting requested ones of the template files, the template parts lists and the media content files and a requested scheduling file.

The requesting display system executes projector software for reading the requested scheduling file to determine which of the requested template files to process according to the schedule. Processing a downloaded template file causes the downloaded template file to reference a downloaded template parts list in order to identify which of the content elements are associated with the selected content element types and to retrieve said identified content elements from the corresponding media content files in order to build the multimedia presentation.

The accompanying drawings, which are incorporated in and constitute a part of the specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended figures, in which:

FIG. 1 is a schematic illustration of an exemplary multimedia distribution system according to certain embodiments of the present invention;

FIG. 2 is a schematic illustration of an exemplary display system architecture according to certain embodiments of the present invention;

FIG. 3 is a schematic illustration of an exemplary distribution server architecture according to certain embodiments of the present invention;

FIG. 4 is a flow chart illustrating exemplary steps for login and synchronization of a display system according to certain embodiments of the present invention;

FIG. 5 is a flow chart illustrating exemplary steps for login and modification of a scheduling file by a display administrator according to certain embodiments of the present invention;

FIG. 6 is a flow chart illustrating exemplary steps for login and upload of media content files and director files by a content administrator according to certain embodiments of the present invention;

FIGS. 7-19 illustrate exemplary user interface functionality for a display administrator according to certain embodiments of the present invention;

FIG. 20 is a graphical representation of an exemplary director template file according to certain embodiments of the present invention;

FIG. 21 is a graphical representation of a multimedia presentation built by a director template file according to certain embodiments of the present invention;

FIG. 22 is a graphical illustration of relationships between a director template file, a template parts list and a content database in accordance with certain embodiments of the present invention;

FIG. 23 is a flow chart illustrating exemplary processing used to display a multimedia presentation using director template files in accordance with certain embodiments of the present invention; and

FIG. 24 is an illustration of an exemplary fast-food restaurant environment for implementation of certain embodiments of the present invention.

Repeat use of reference characters in the present specification and drawings is intended to represent same or analogous features or elements of the invention.

### DETAILED DESCRIPTION OF THE PREFERRED EMBODIMENTS

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

One or more of the preferred embodiments of the present invention as described below operates within and/or in conjunction with a network. Generally, such a system includes multiple memory storage and computing devices located remotely from each other. The execution of program applications may occur at these remote computing sites as data is transferred among the memory storage devices and between the computing devices over an extended system. Examples of networks include the Internet, local and wide area networks, virtual private networks, and point-to-point systems. The Internet is a global accumulation of computer networks linked by routers and other devices that direct communication among the networks through an information retrieval system, most commonly the World Wide Web.

Certain operations and processes described herein are executed by one or more computers within a network or networks. As should be well understood, a computer transforms information in the form of electronic signals input into the computer to desired output. The input may be provided by a human operator, another computer, or from other external sources. To accomplish these functions in one computing environment, a conventional general purpose computer includes a processor, read-only and random-access memory storage, a bus system and input/output systems to transfer information within the computer and to interact with external devices. The computer's memory storage stores such things as an operating system and various application programs that run on the operating system. The computer's memory storage may be made up of one or more physical computer-readable mediums.

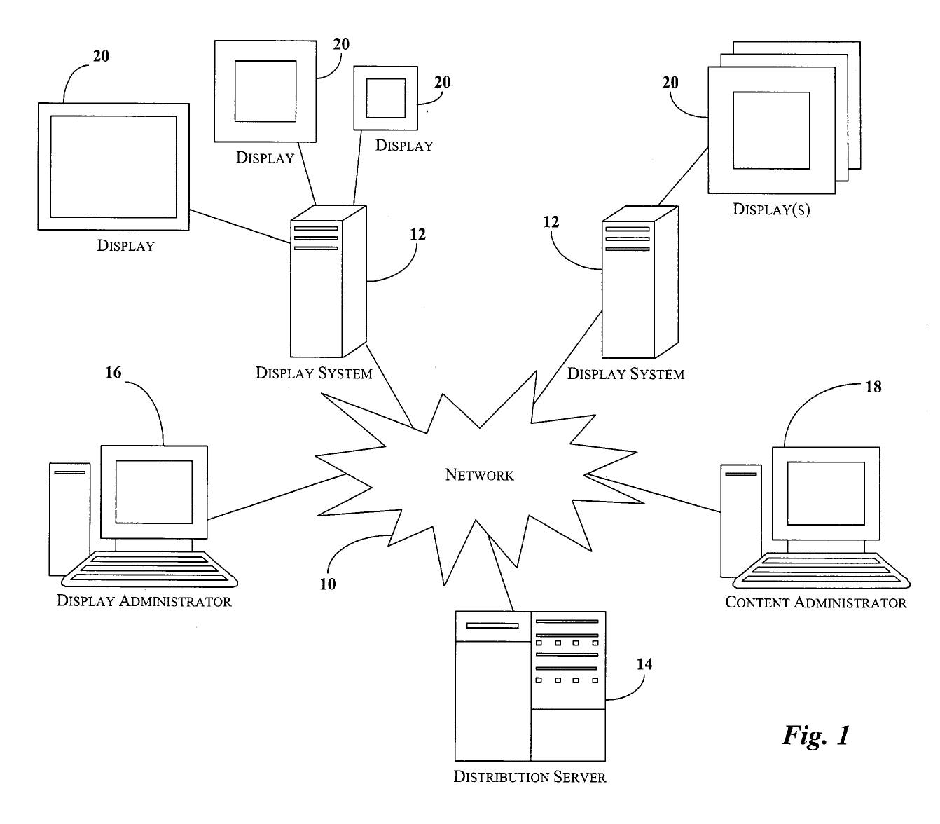

Referring to FIG. 1, an exemplary multimedia distribution system includes a plurality of display systems 12, a plurality of display administrators 16 (only one of which is shown in FIG. 1) and a plurality of content administrators 18 (only one of which is shown in FIG. 1) connected to a distribution server 14 via a network 10. Each display system 12 drives one or more respective displays 20 with multimedia presentations and is capable of periodically downloading updated presentations content and scheduling information from the distribution server 14. Display administrators 16 determine the content that is provided on specific display systems 12 and the schedule for displaying the content on specific displays 20. A given display administrator 16 may control the content and scheduling for multiple display systems 12, depending upon which display systems 12 are associated with the display administrator 16. Content administrators 18 control a master set of content from which display administrators 16 can choose in determining the content to display on particular display systems 12.

Although network 10 is generally described herein as the Internet, the method of exchanging data within the present system is not limited to the Internet and may be implemented in the context of any network environment. It should be clear to one of ordinary skill in the art that display systems 12, display administrators 16, content administrators 18 and distribution server 14 can be networked using various suitable devices, platforms and network architectures.

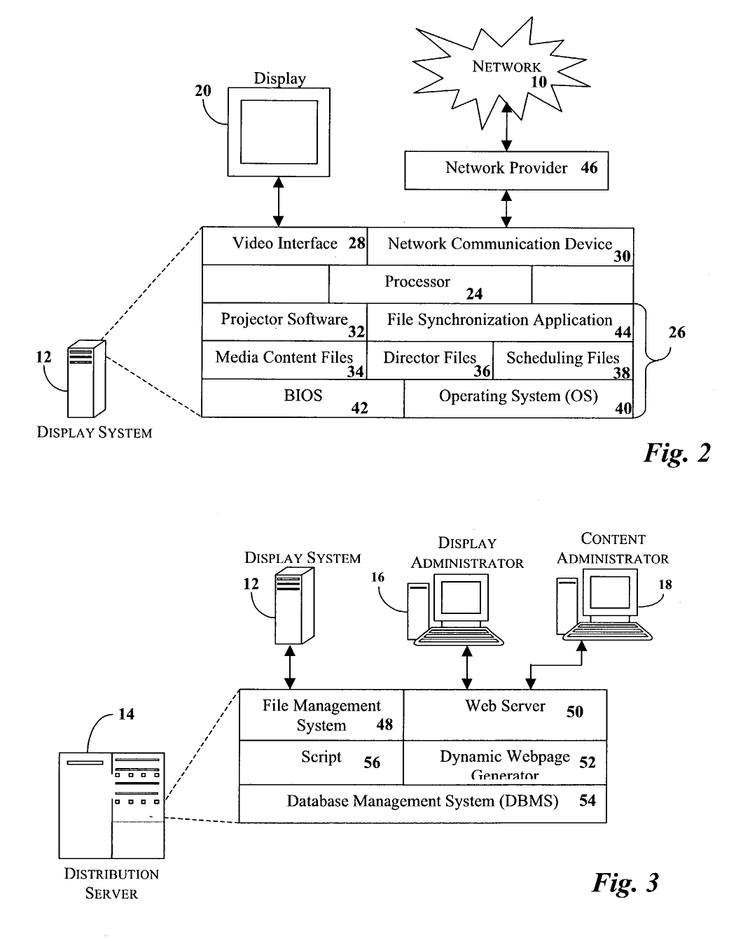

Referring to FIG. 2, each display system 12 drives at least one display 20 with a multimedia presentation through a suitable connection, for example hard wire or wireless, to a video interface 22. Each display system 12 may simultaneously drive multiple displays 20 either individually or as a group. In other words, the display system 12 may drive the displays 20 so that they provide the same or different presentations. The term “display” is meant to be broadly used to encompass any electronic screen capable of displaying information, such as a liquid crystal displays (“LCD”), plasma displays or cathode ray tube (CRT) monitors. By way of example only, other types of display screen technologies that may be used in conjunction with the present invention include polysilicon thin film transistor (“TFT”), super twisted nematic (“STN”), twist nematic (“TN”) or electro-luminescence. In addition, vacuum fluorescent displays, field emission displays, digital micro mirror devices or light emitting diodes display technology may also be used. The applicants also consider that plasma addressed liquid crystal displays, anti-ferroelectric liquid crystal displays or ferroelectric liquid crystal displays can be used to provide a display 20 in conjunction with the present invention.

Display systems 12 need not be configured with proprietary hardware, but may be built with off-the-shelf components. It should be clear to one of ordinary skill in the art that display systems 12 may be configured from any general-purpose computer, having a processor 24, memory storage 26, video interface 28 and means for communicating with a network 10, such as a network interface card, modem, or other network communication device 30. The memory storage 26 may store such things as projector software 32, media content files 34, director files 36, scheduling files 38, an operating system 40, a BIOS 42, and a file synchronization application 44 (explained below). Depending upon the required flexibility, a display system 12 could also be implemented in an imbedded system specifically programmed to display presentations and update the content with information on distribution server 14.

Display systems 12 may execute projector software 32 that allows a selected multimedia presentation to be played on a given display 20. MACROMEDIA DIRECTOR, available from Macromedia, Inc. of San Francisco, Calif., can be used to create a standard projector file or a stub projector file. With a standard projector file, the media content files 34 and their director file 36, which directs the display of the content within a given presentation, are compiled into a single executable file. Alternatively, the media content files 34 may be stored externally of a stub projector file, which in turn contains instructions regarding the location of the media content files 34 to be played in the presentation. In one embodiment, the projector software 32 executed by a display system 12 is a customized stub projector that reads an external scheduling file 38 to determine the directory location of the media content files 34 and the timing at which presentations are to be played.

Thus, the system employs scheduling files 38 to identify presentations to be displayed at a given display system 12 and the timing at which the presentations will be played. The presentations are defined by director files 36 and their associated media content files 34. Although the function and structure of scheduling files 38 will be further described herein in more detail, the following is an example line from a scheduling file 38 that may be helpful in understanding the function of the custom stub projector:

[#type:#display, #when: [#hour:06, #minute:00], #where:1, #media:
[[#filename: “fulldemo.dir”, #coords: [426,240]]]]

The custom stub projector may be written with instructions, preferably in the LINGO language, that allow the projector to parse lines of the scheduling file 38. In the example, the projector realizes that the presentation controlled by the director file 36 “fulldemo.dir” should be played at 6:00 a.m. The director file 36 resides in the local directory from which the stub projector runs and includes the location of the media content file(s) 34 containing the content itself. Although it is believed that use of a stub projector in the above-described manner is new, the description herein should provide one of ordinary skill in the art with the necessary information for the creation and use of such a custom stub. Accordingly, the programming instructions used to create such a stub projector will not be discussed in detail herein.

Display systems 12 update presentations and scheduling through a file synchronization application 44 that periodically connects to distribution server 14 and downloads current presentation content (i.e., media content files 34 and/or director files 36) and scheduling files 38 to a database located within the memory storage 26 of the display system 12 or in another storage device accessible by the display system 12. In certain exemplary embodiments, distribution server 14 does not push information to display system 12; instead, each display system 12 periodically checks for updates and downloads information particular to the display system 12.

A file synchronization application 44, for example ROBOCOPY, may be used to synchronize files between display systems 12 and distribution server 14. ROBOCOPY is distributed with WINDOWS NT and allows a directory on a display system 12 to mirror a directory on distribution server 14 corresponding to the display system 12 by periodically copying files to the display system 12 from the distribution server's corresponding directory and automatically deleting files from the display system 12 that no longer exist on the distribution server directory. ROBOCOPY has the ability to perform a partial download. For example, if a display system 12 is disconnected from the distribution server 14 during a download, RODOCOPY can continue the download from the point that the display system 12 was disconnected, without restarting the download from the beginning.

Display systems 12 may access the network 10 via a network provider 46. Display systems 12 may communicate with a network provider 46 using any suitable network connection technology, for example analog, cable, DSL, T1, T3, OC3, OC12, OC48, OC192 or any other network connection technique. As previously mentioned, devices used in the present system may be networked using any of a variety of network configurations. If the Internet is the medium for information exchange, display systems 12 may access the Internet using any suitable Internet service provider. By connecting to an Internet service provider, the display systems 12 thereby have access to the Internet.

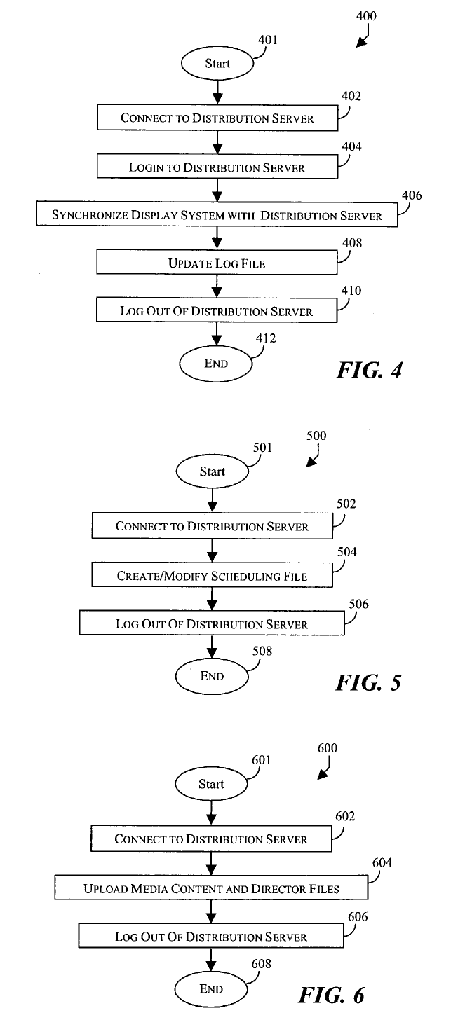

Referring also to FIG. 3, media content files 34, director files 36 and scheduling files 38 may be stored on distribution server 14, which may be configured to have a separate directory for each display system 12. Each respective directory may be identified by an identification unique to its corresponding display system 12. The media content files 34, director files 36 and scheduling files 38 for each display system 12 may reside in the respective directories or may reside in one or more general directories from which they are linked to the respective directories by an association file. An association file may contain a table or other data structure that maintains a set of associations between the respective directories and the media content files 34, director files 36 and scheduling files 38 located elsewhere on the distribution server 14. Each respective directory may contain a status file having a direction to the association file or a direct link to the media content files 34, director files and scheduling files 38 corresponding to a specific display system 12.

To retrieve the media content files 34 and scheduling files 38, the display system's file synchronization application 44 (e.g. ROBOCOPY) establishes a connection over the network 10 (FIG. 1) to distribution server 14. Based upon the file management system 48 in use on the distribution server 14, the display system 12 is automatically directed to its corresponding (home) directory on the distribution server 14. Where an association file is used, a status file in the home directory directs the display system 12 to the association file (e.g., a look-up table), which then identifies the media content files 34, director files 36 and scheduling files 38 available to the display system 12. In the situation where stub projectors are used to display presentations, media content files 34 and scheduling files 38 may be updated without the need to update the stub projector file. In the situation where standard projector files are used, updated media content files 34 must be re-compiled into the associated director file 36.

Once the files available to a display system 12 are identified, the file synchronization application 44 may synchronizes the display system 12 with those files. As should be understood in this art, SAMBA is an example of a file management system 48 that defines directories and files that are available to a given user. Other suitable file management systems 48, such as COMMON INTERNET FILE SYSTEM (“CIFS”), NETWARE, APPLETALK AND BANYAN VINES, could also be used. Display systems 12 may be grouped using a common identifier. Thus, the grouped display systems 12 may be provided with access to the same media content files 34, director files 36 and scheduling files 38.

Referring to FIGS. 1, 3 and 7-19, display administrators 16 and content administrators 18 may be configured to execute web browsers, through which these devices can access the distribution server 14 to manipulate the media content files 34, director files 36 and scheduling files 38 available to the various display systems 12. Although access using a web browser was chosen for simplicity and platform independence, it should be clear to one of ordinary skill in the art that various other techniques for accessing and modifying data files on a distribution server 14 could be substituted. Although browser software communicates with distribution server 14 preferably using HTTP, other embodiments of the present system and method could be adapted to networks that do not employ HTTP.

In order to provide access to data files stored in the distribution server's database via a web browser, distribution server 14 runs web server software 50 capable of communication with a database housing media content files 34, director files 36 and scheduling files 38. Any suitable web server software 50, such as APACHE or INTERNET INFORMATION SERVER (“IIS”), could be used. Accordingly, the distribution server 14 hosts a web site that provides display administrators 16 and content administrators 18 an interface to its database. The web site may dynamically generate web pages using a dynamic web page generator 52 that may be based on PHP, Active Server Pages (“APS”), or any other language capable of dynamically generating web pages. Through the web site, display administrators 16 may choose presentations for, and content administrators 18 may upload additional content for, particular display systems 12. This process is described in more detail below.

Since distribution server 14 runs web server software 50 to provide access to display administrators 16 and content administrators 18, distribution server 14 may be implemented using any technique that increases the performance of web servers. As a result, distribution server 14 may actually be split across more than one physical computer using, for example, load balance techniques such as DNS balancing. DNS balancing uses multiple identical copies of the site on separate physical computers. The DNS server for the hostname of the site, such as www.sample.com, is set up to return multiple IP addresses for the site. The DNS server can do this by either just returning more than one IP address for the hostname or returning a different IP address for each DNS request it receives. Accordingly, multiple users accessing the same web site will actually be accessing different computers to balance the load on the web server.

Distribution server 14 houses multiple types of data files that are used by display systems 12 to run multimedia displays and control the scheduling of the displays, including but not limited to: media content files 34, director files 36, scheduling files 38 and status files (not shown). Media content files 34 contain the raw segments of data (also referred to as content elements) that are used to build a multimedia presentation. For example, media content files 34 may contain sound, video segments, pictures, text, or other content elements that are desired in a multimedia presentation. The particular format of the media content files 34 may depend on the display system 12 used and is not, in and of itself, part of the present invention.

Director files 36 arrange a set of media content files 34 into a multimedia presentation. Director files 36 are the files run by the previously-mentioned projector software 32 to display the multimedia presentation. Each display system 12 may have multiple director files 36 and corresponding media content files 34 so that multiple multimedia presentations can be displayed by a display system 12.

Scheduling files 38 determine the timing at which display systems 12 play the director files 36. Scheduling files 38 are text files that are read by the projector software 32 to determine the sequence and timing at which presentations are played. An exemplary scheduling file 38 may have the following format:

[#year:2000, #month:11, #day:21, #hour:17, # minute:41, #second:0]
[#type:#display, #when: [#hour:06, #minute:00], #where:1, #media:
[[#filename.fulldemo.dir, #coords:[426,240 ]]]]
[#type:#display, #when: [#hour:09, #minute:001, #where:1, #media:
[[#filename:fulldemo1.dir, #coords:[426,240]]]]
[#type:#display, #when: [#hour:10, #minute:00], #where:1, #media:
[[#filename:fulldemo2.dir, #coords:[426,240]]]]
[#type:#display, #when: [#hour:12, #minute:00], #where:1, #media:
[[#filename:fulldemo3.dir, #coords:[426,240]]]]
[#type:#display, #when: [#hour:14, #minute:00], #where:1, #media:
[[#filename:fulldemo4.dir, #coords:[426,240]]]]

The first line in the exemplary scheduling file 38 sets forth the creation date of the scheduling file 38. The projector software 32 periodically checks the scheduling file's creation date to determine if a new scheduling file 38 has been downloaded since the previous check. If the projector software 32 determines that the creation date has changed, it loads the remaining lines in the scheduling file 38 to determine the new presentation schedule. As described above, each subsequent line identifies a director file 36 and the time it should be played. Schedule execution is discussed below.

Scheduling files 38 may be automatically generated on distribution server 14 based upon scheduling entries made by the display administrator 16. Scheduling entries may be stored in a database, such as an SQL database, that is housed in or otherwise accessible to the distribution server 14. A database management system 54, such as MySQL, may be programmed to execute a script 56 or other software code for pulling the appropriate scheduling entries from the database and putting that information in the proper format for a scheduling file 38. Those skilled in the art will appreciate that PERL and other scripting languages may be used to create a script for generating scheduling files 38. The function of and scheduling entries made by a display administrator 16 will be further described in more detail below.

Scheduling files 38 may take into account dynamically generated external data in order to determine which director file 36 to play. For example, scheduling files 38 may dynamically schedule the times for playing director files 36 based upon real time point-of-sale (“POS”) data. In this case, the projector software 32 may be programmed to not only read the scheduling file 38, but also to read an external file that contains the relevant data, such as POS data. Depending upon the external data, the projector software 32 may override or change the values in the scheduling file 38. For example, where the content of the multimedia presentation played by the projector software 32 relates to a restaurant menu or retail store advertisement, the external file may contain an inventory list that is dynamically updated by the store's cash register system. If sales of certain items slow, as indicated by the inventory population, the external file may override or change the scheduling file 38 to cause the projector software 32 to play multimedia presentations intended to encourage sale of those items. Similarly, the external file may contain dynamically updated weather data that may be used to change advertisements in a store whose sales traffic is affected by the weather. Furthermore, a user controlling the display system 12 may optionally override the scheduling file 38 through input commands, such as by typing ‘page up/page down’ buttons on a keyboard connected to the display system 12 to scroll through available multimedia presentations.

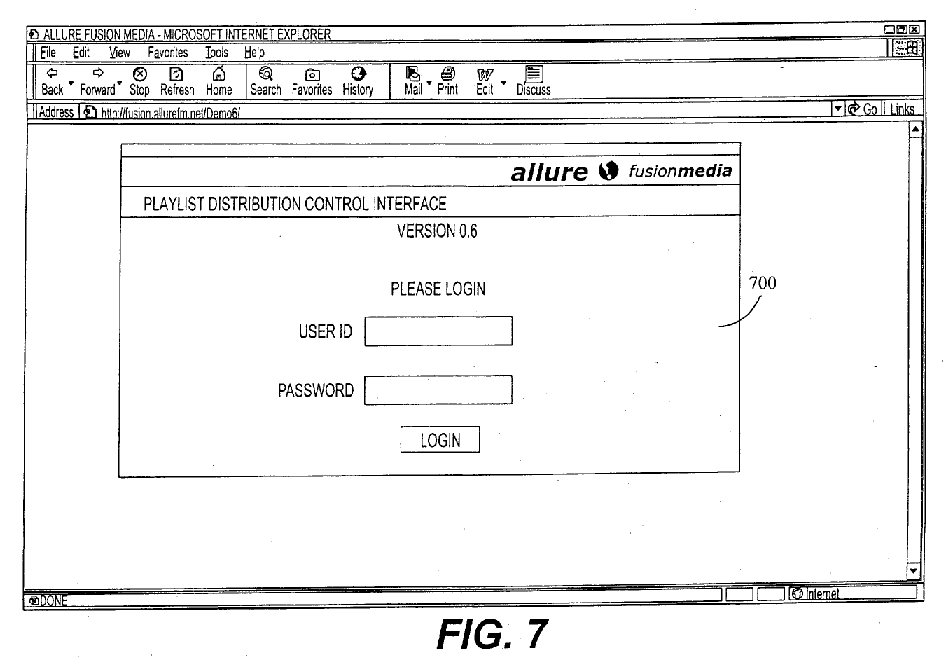

Referring to FIG. 4, there is shown a flow chart illustrating the periodic synchronization of display systems 12 with distribution server 14. In certain embodiments, instead of pushing information to display systems 12 from the distribution server 14, display systems 12 periodically connect to distribution server 14 and download updated information. Upon startup, and periodically during operation, each display system 12 may connect to distribution server 14 to download any updates. The display system 12 may run a set of scripts to control the periodic synchronization. For example, a start-up script may automatically upload status information to the distribution server 14 upon powering-on the display system 12. A synchronization script may launch the file synchronization application 44, e.g., ROBOCOPY, periodically to synchronize media content files 34 and scheduling files 38 with the distribution server 38.

The exemplary synchronization method 400 begins at start step 401 and advances to step 402, where the display system 12 connects to the distribution server 14. Next at step 404, the display system 12 logs in to the distribution server 14. In certain embodiments, a display system 12 may log into distribution server 14 using a unique identifier assigned to the display system 12. As a result, display system 12 may be provided with access to the directory on the distribution server 14 corresponding to its unique identifier (i.e. its home directory). Next at step 406, the display system 12 synchronizes with the media content files 34, director files 36 and scheduling files 38 in (or linked to) the home directory according to a status file. That is, the display system 12 downloads any updated data files from distribution server 14 and deletes from its local memory storage 26 the old files corresponding to the new files. Once display system 12 is synchronized, the appropriate status file is updated at step 408, and any errors occurring in the download or operation of the display system 12 are noted. At that point, display system 12 logs off of distribution server 14 at step 410 and the exemplary synchronization method 400 ends at step 412.

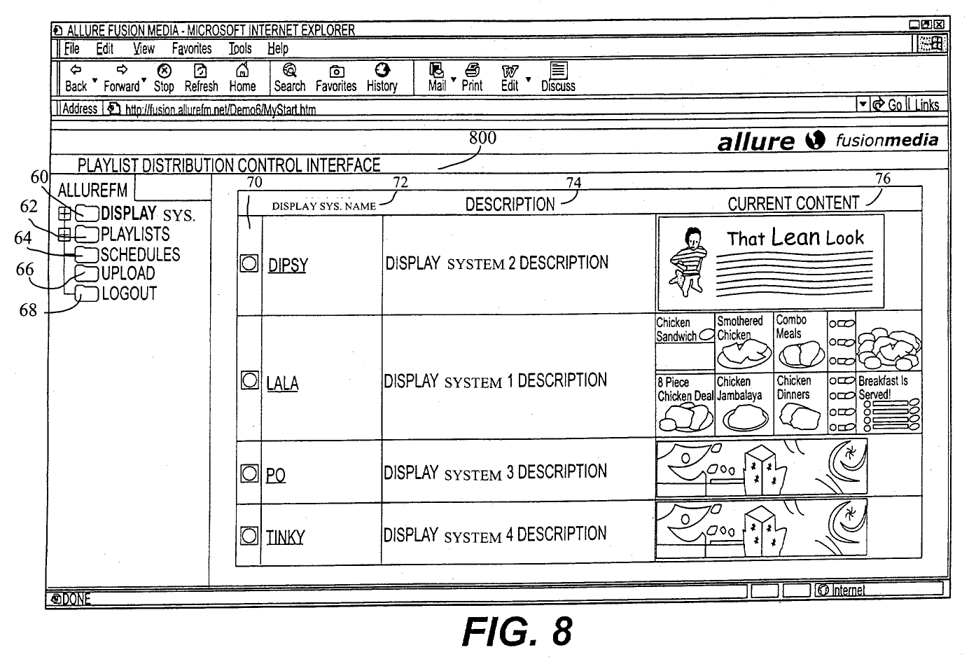

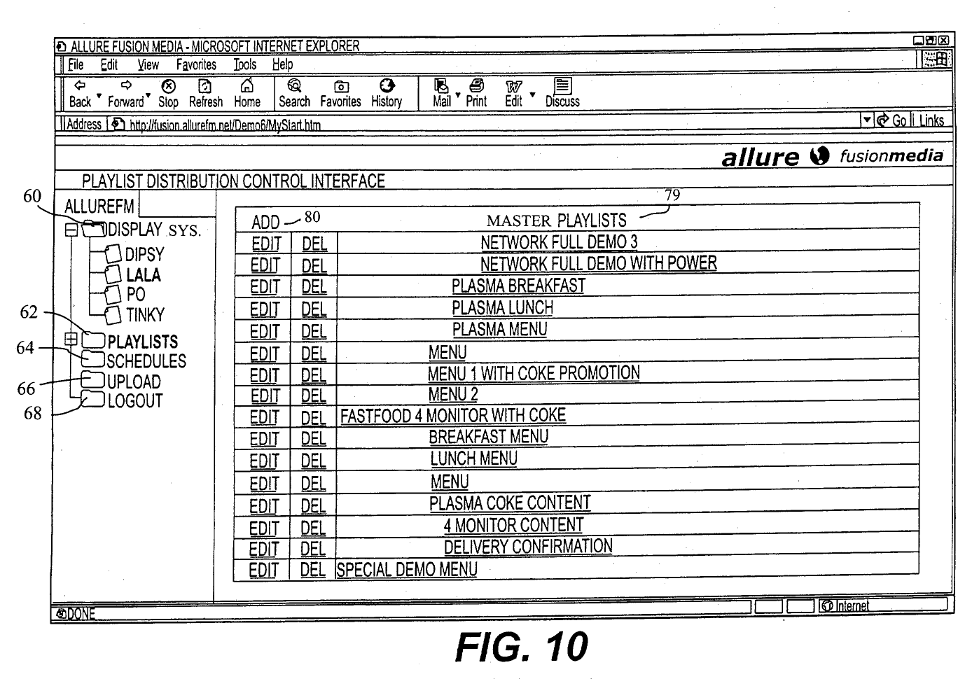

Referring to FIGS. 5 and 7-19 there is shown a flow chart illustrating the interaction between a display administrator 16 and distribution server 14. Display administrators 16 determine the content available to specific display systems 12, or group of display systems 12, through director files 36 and scheduling files 38. The exemplary display administration process 500 begins at start step 501 and proceeds to step 502, where the display administrator 16 connects to the distribution server 14, for example via a web browser. Display administrator 16 next logs into distribution server 14 at step 504. The web server software 50 of the distribution server 14 may present a web page that prompts the display administrator 16 for a user name and password. An exemplary login screen 700 is shown in FIG. 7.

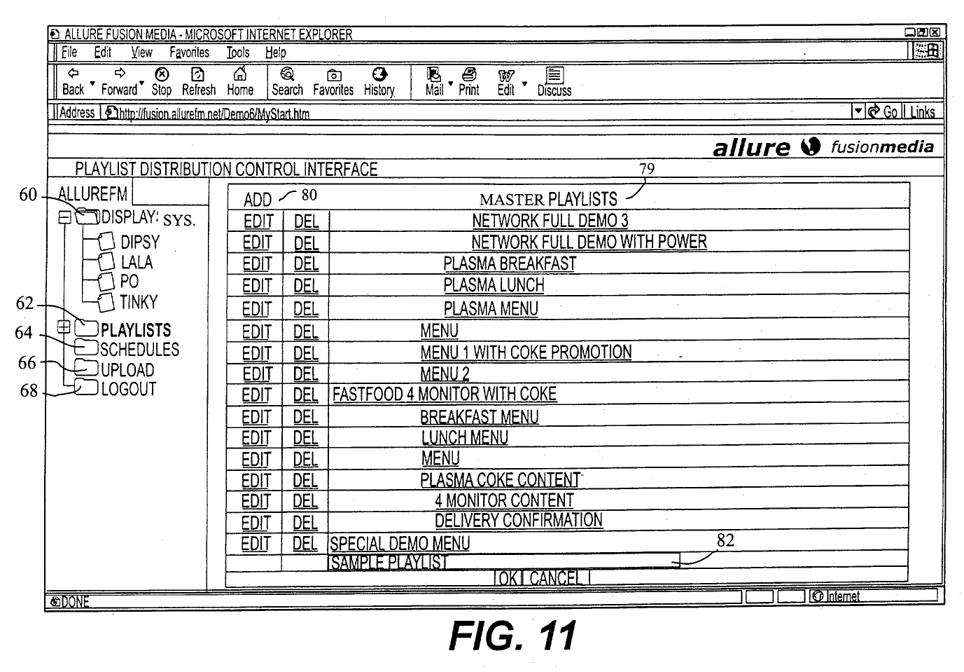

At step 506, the display administrator 16 inputs commands, parameters and/or other entries that will be used by the distribution server 14 to create or modify scheduling files 38. As previously mentioned, such entries made by the display administrator 16 may be stored in a database, which may subsequently be accessed by a script 56 or other software code for generation of scheduling files 38. Exemplary graphical user interface screens for allowing the display administrator 16 to input such entries are shown in FIGS. 8-19. However, it should be understood that numerous interfaces could be designed which obtain the information needed from the user of the display administrator 16.

Referring to FIG. 8, if the display administrator successfully enters the login information, the web server software 50 presents a “Playlist Distribution Control Interface” 800. On the left portion of the exemplary Playlist Distribution Control Interface” 800, the display administrator 16 is presented with a “Display Systems” tab 60, a “Playlists” tab 62, a “Schedules” tab 64, an “Upload” tab 66 and a “Logout” tab 68. With the Display Systems tab 60 selected, the interface shows summary information about each display system 12 that the display administrator 16 has permission to control. In the main frame of the interface, the columns from left to right have rows for each display system 12 that show a status indicator 70, display system name 72, display system description 74, and a representation of the current presentation being displayed 76. The status indicator 70 corresponds to the status file associated with the particular display system name 72. In certain embodiment, the status indicator 70 is green if the display system 12 has not reported any errors, but is red if errors have been reported by the display system 12. The representation of the current multimedia presentation 76 is preferably an animated GIF (“Graphics Interchange Format”) file that simulates the multimedia presentation currently being displayed by the display system 12.

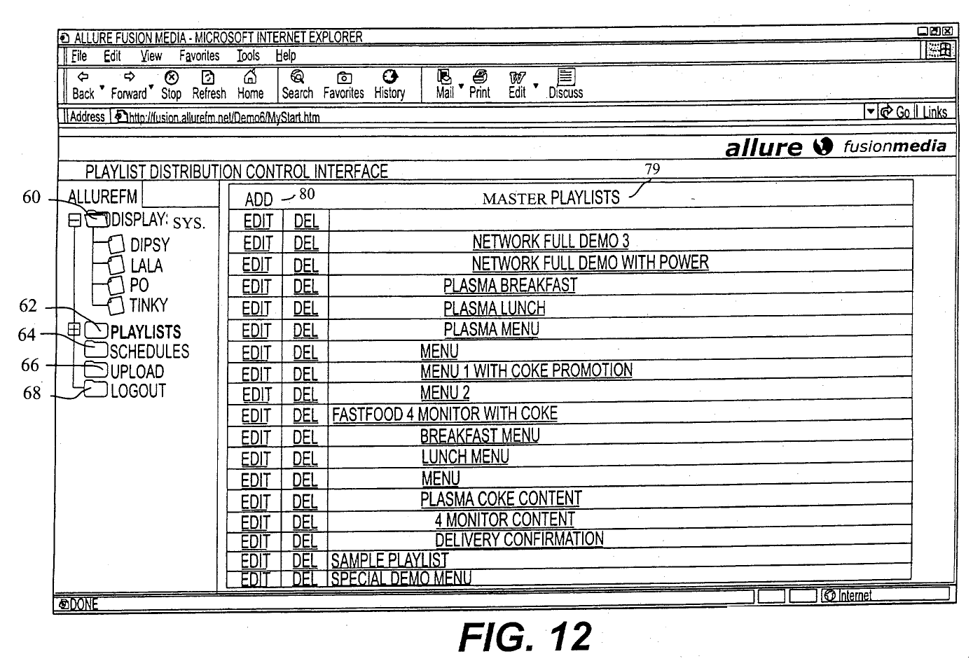

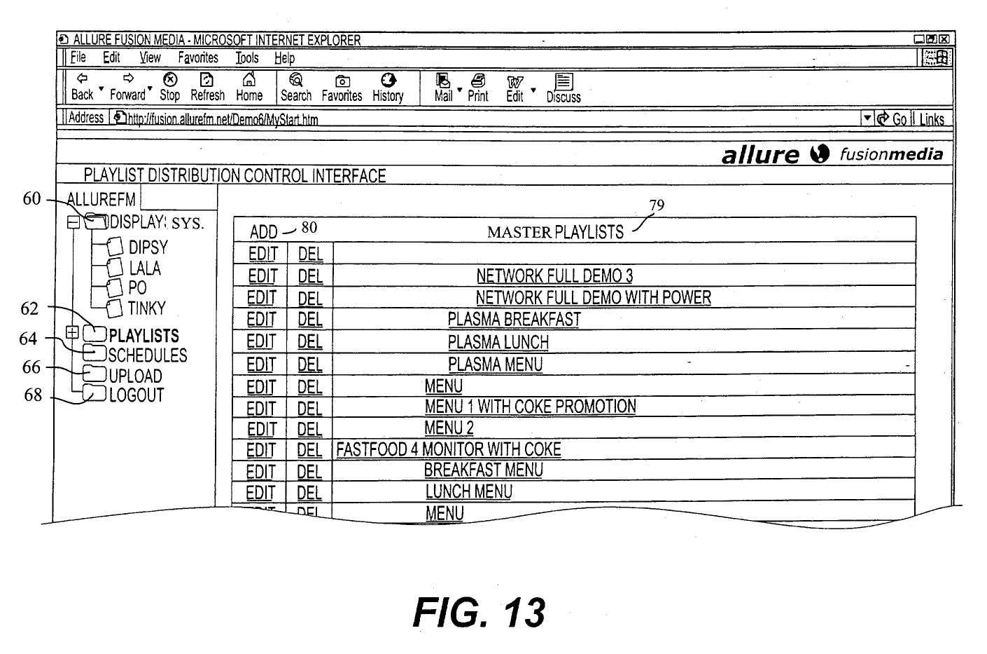

By selecting a specific display system name 72, the Play List Distribution Control Interface 800 is changed as shown in FIG. 9 to show more detailed information about the corresponding display system 12. In addition to the summary information provided in FIG. 8, FIG. 9 allows the display administrator 16 to view, edit, reschedule or delete playlists 78 for a specific display system 12. Playlists 78, as will be described below, associate director files 36 with times for starting play thereof. When the Playlists tab 62 is selected, a master (complete) playlist 79 is displayed, as shown in FIG. 10. The master playlist 79 includes all playlists 78 that the display administrator 16 has permission to use.

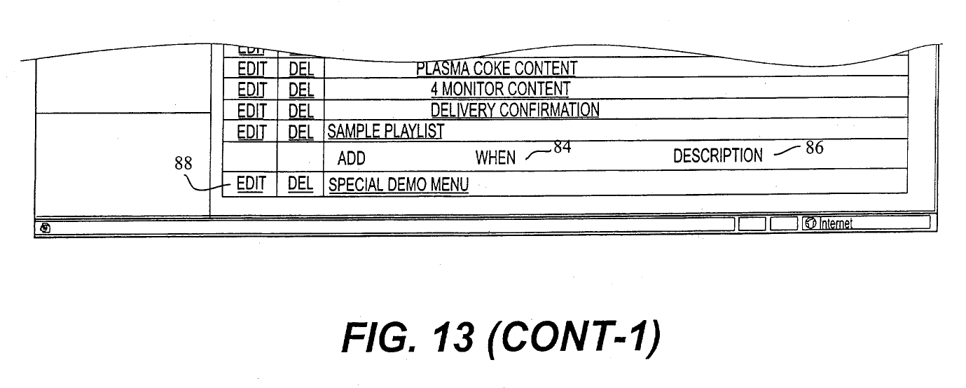

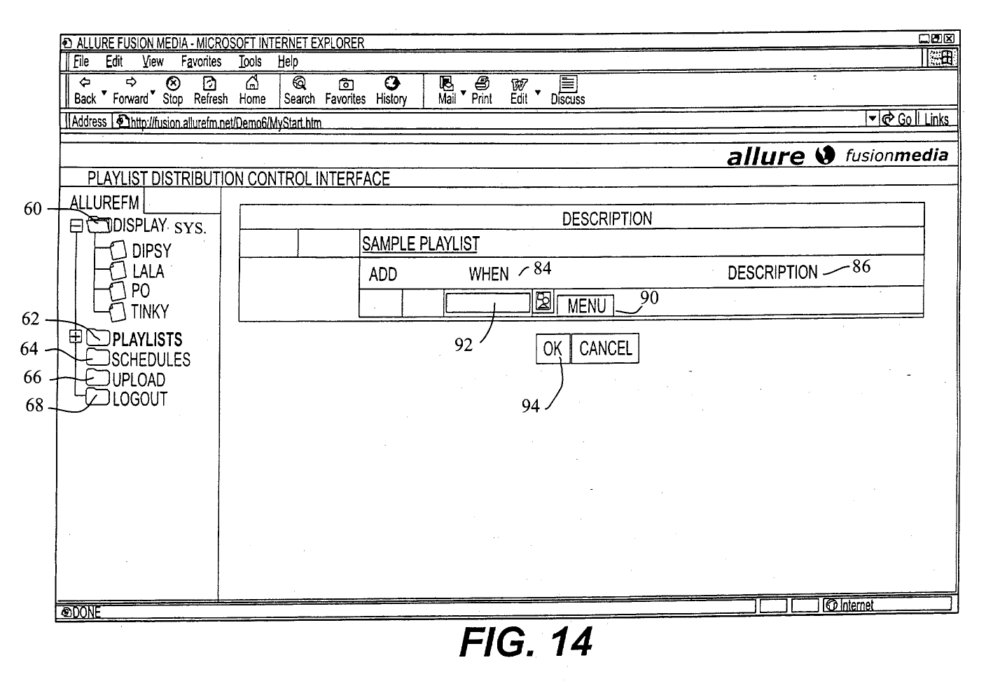

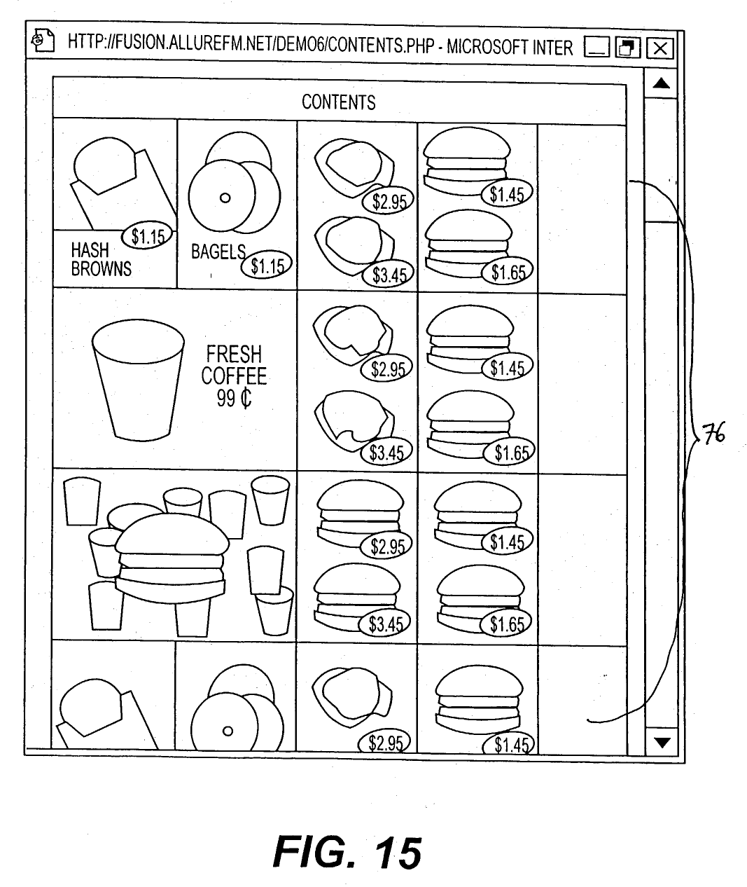

A display administrator 16 may associate a playlist 78 with a selected display system name 72 (FIG. 9) or add the playlist 78 to the master playlist 79 (FIG. 10), by selecting an “Add” hyperlink 80, at which point the system presents a text box 82 as illustrated in FIG. 11. The display administrator 16 may input a new playlist name, such as “sample playlist,” into the text box 82. After the display administrator is finished specifying the new playlist name, it may be added to the master playlist 79 as illustrated in FIG. 12. By selecting a specific playlist 78, such as “sample playlist,” from the master playlist 79, additional information, such as scheduling (“when”) information 84 and a playlist description 86, may be displayed for the selected playlist 78, as illustrated by FIG. 13. In the example shown, the scheduling information 84 and the playlist description 86 for the newly created “sample playlist” have not yet been specified.

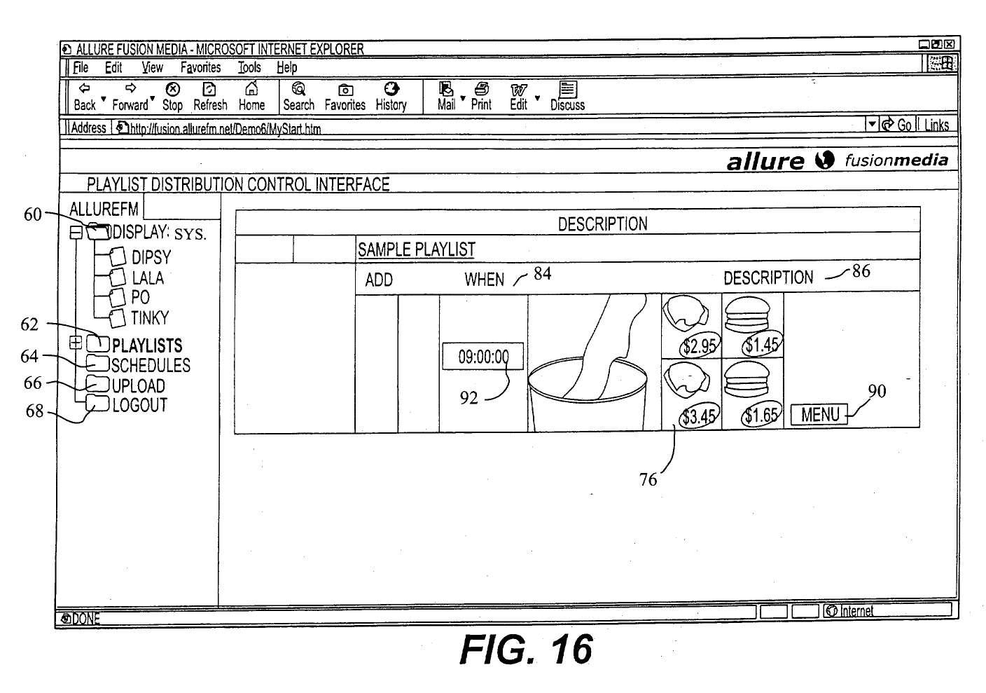

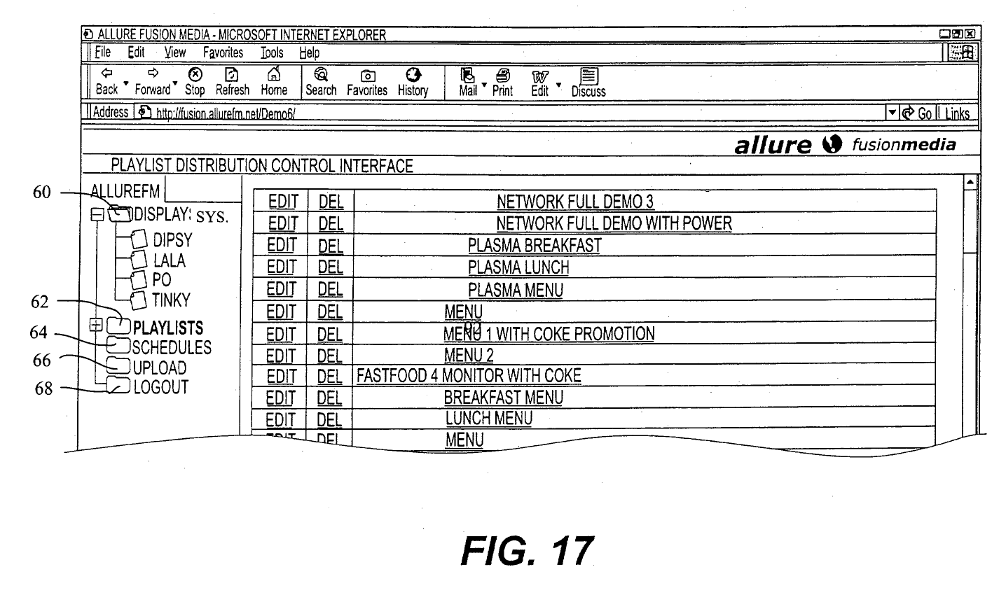

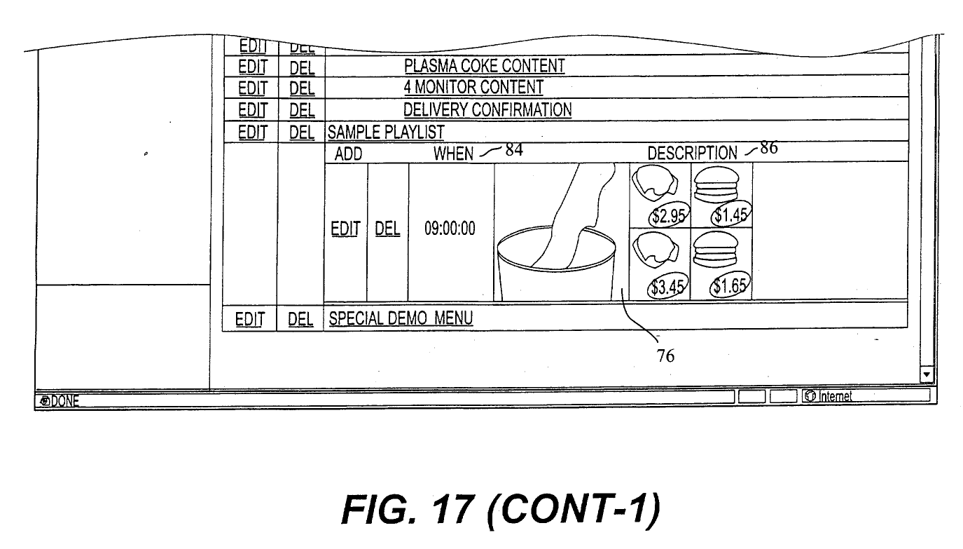

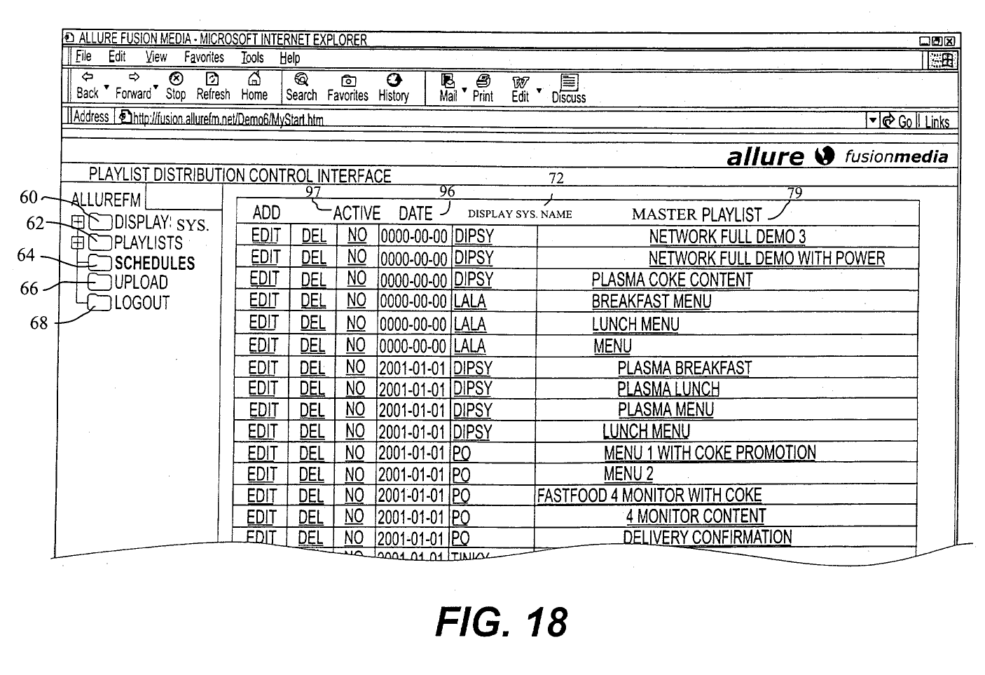

By selecting the “edit” hyperlink 88 adjacent to a particular playlist 78, the display administrator 16 is presented with a new interface that allows selection of different multimedia presentations and scheduling information 84 therefor, as illustrated in FIG. 14. If the “menu” button 90 is selected, a set of representations of available multimedia presentations 76 is shown in a new window, as shown in FIG. 15. Again, a representation of a multimedia presentation 76 is preferably an animated GIF file that simulates the multimedia presentation. Once a multimedia presentation is selected for the playlist 78, the selected presentation is shown as the playlist description 86, as illustrated in FIG. 16. Additionally, the display administrator 16 can specify the scheduling information 84 for the selected multimedia presentation by entering a time into the time text box 92. The scheduling information 84, in preferred embodiments, is the time that the multimedia presentation will start to be displayed. That is, this scheduling information 84 will be used to define the time component in the scheduling file 38 associated with the director file 36 that generates the selected multimedia presentation. Beginning at the specified start time, the display system 12 will play the selected multimedia presentation until the start time for the next multimedia presentation occurs, i.e. until a new presentation is scheduled. Once the scheduling information 84 and playlist description 86 are added, the user may select the “ok” button 94 to cause the master list 79 to be updated with the new information, as shown in FIG. 17.

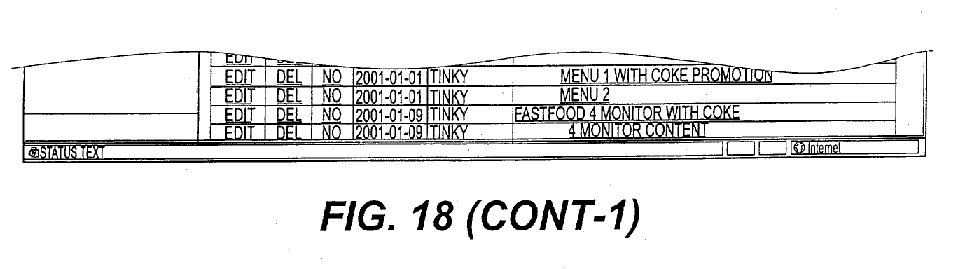

Referring to FIG. 18, the display administrator 16 can assign playlists 78 and dates 96 to specific display system names 72 by selecting the Schedules tab 64. With the Schedules tab 64 selected, the interface shows each playlist 78 that the display administrator 16 has permission to control and the display system name 72 to which it is assigned. An active presentation indicator 97 may be used to indicate whether the playlist 78 will be updated on the specified display system 12; a “yes” meaning that the playlist 78 should be downloaded to the display system 12 and a “no” meaning that the playlist 78 should not be downloaded to the display system 12. The date 96 associated with a playlist 78 represents the date that the display system 12 will be updated with the specified presentation, assuming the active indicator is “yes.”

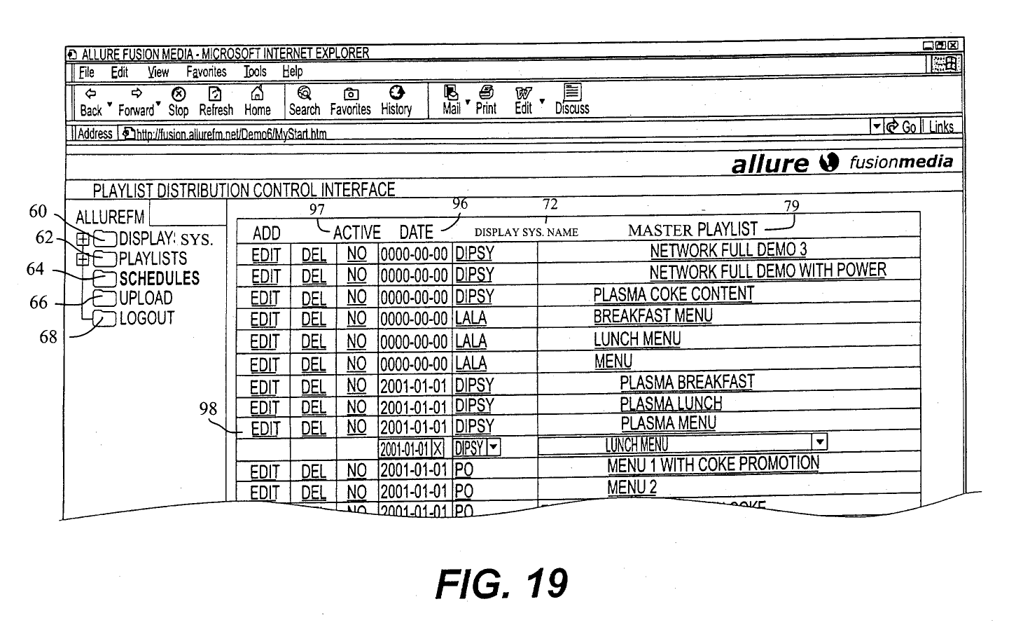

FIG. 19 illustrates the interface options if an “edit” hyperlink 98 is selected in FIG. 18. The display administrator 16 can change the date 96, the display system name 72, and the playlist 78 by selecting from drop-down menus or interacting with other suitable interface controls. Once the display administrator 16 has entered all desired entries, selecting the Logout tab 68 disconnects the display administrator 16 from the distribution server 14.

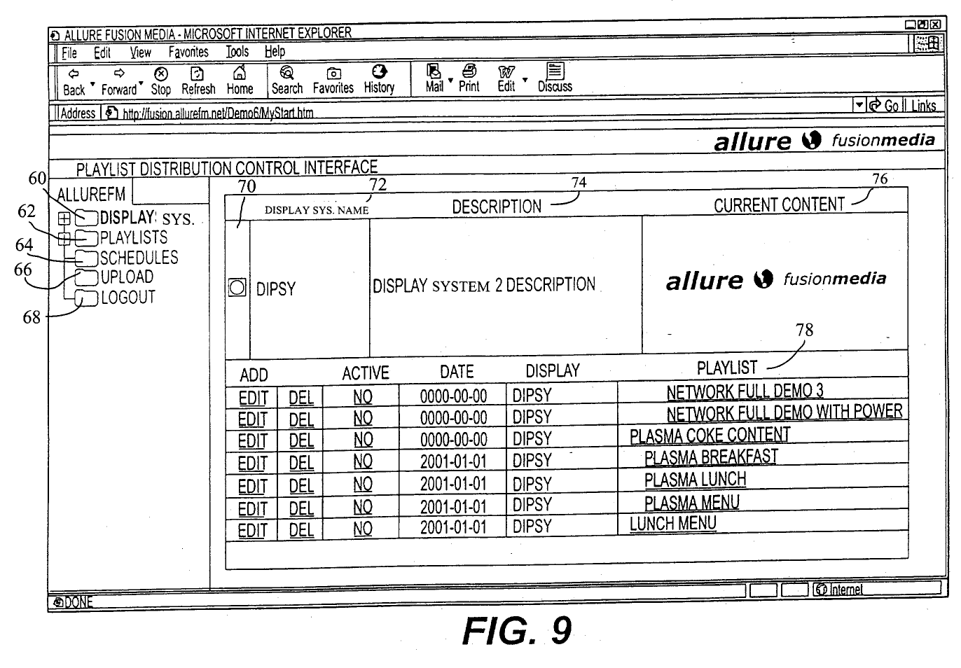

FIG. 6 provides a flow chart illustrating the interaction between a content administrator 18 (FIG. 1) and distribution server 14. Content administrators 18 control the master set of content files from which display administrators 16 can choose in determining the content to display on specific display systems. Preferably, content administrators 18 log in to distribution server 14 via a web browser in a manner similar to that discussed above with respect to FIG. 7 for display administrators. The distribution server's web server software then presents an interface (FIG. 8) through which content administrators 18 may upload director files 36 and corresponding media content file 34 to the distribution server 14. Upon selecting the “upload” tab, the content administrator 18 establishes an FTP connection with the distribution server 14 for uploading content files 34 and director files 36. Once these files have been uploaded to distribution server 14, content administrator 18 may log off distribution server 14.

For purposes of illustration only, the following example illustrates the use of the present system with respect to the owner of a franchise having a display system 12 in each of four business locations. Initially, the franchiser logs into distribution server 14 as content administrator 18 and uploads a master set of content files 34 that could be used by all members of the franchise (i.e. by all display systems 12 for which this particular content administrator 18 is authorized). Next, the owner selects the particular presentations and scheduling for his four display systems 12 by logging in as display administrator 16. Each of the four display systems 12 is associated with the owner, so the owner can select presentations for each display system 12 and determine the timing at which these presentations will be displayed. If the owner would like to display the same presentations at each location, the four display systems 12 associated with the owner could be set as duplicates. As the four display systems 12 are powered on, each display system 12 connects to distribution server 14 and downloads the updated information. Periodically, these display systems 12 again connect to the distribution server 14 and download updated data. The owner may choose to change the presentations or scheduling as display administrator 16. Likewise, the franchiser may upload additional presentations as described above.

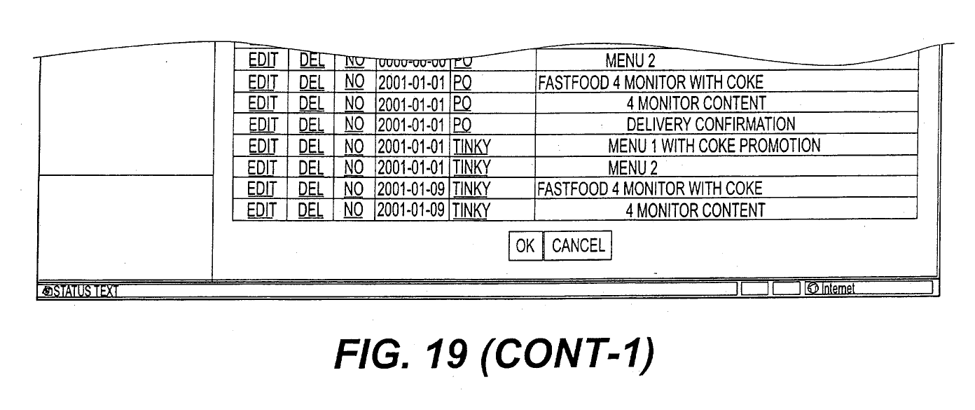

In accordance with certain alternate embodiments of the invention, a director file 36 may be configured in the form of a template, referred to herein as a “director template file” 100. A director template file 100 may define the arrangement and presentation of content element types, as well as specific content elements. FIG. 20 shows a graphical representation of an exemplary director template file 100. The representation shows that a director template file 100 may include and define the arrangement of specific content elements, such as the exemplary image of the words “Why Not Add” 102, the exemplary image of the words “For Only” 104, the exemplary image of the word “More?” 106 and the exemplary graphic of a black oval 108. As in any other director file 36, the author may specify the arrangement of these and other specific content elements in a director template file 100.

In addition, the author of a director template file 100 is able to define “place holders” for other non-specified content elements. These place holders are referred to herein as “content element types.” The exemplary director template file 100 specifies the arrangement and presentation of three content element types named Item Name 110, Item Photo 112 and Item Price 114. Content element types may be assigned attributes that specify the display size and positioning for associated content elements. Optionally, content element types may be assigned attributes to specify the timing for display of associated content elements. Additional attributes, such as color, animation, sound, etc. may also be assigned to content element types.

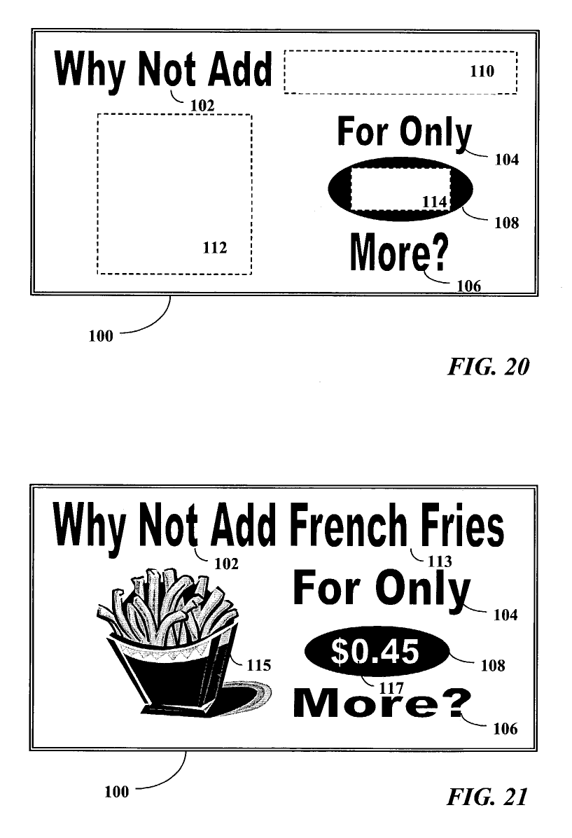

Content element types specified in a director template file 100 may be associated with specific content elements by way of a file referred to herein as a “template parts list” 118, as will be described below. When played by projector software 32, the director template file 100 displays the content elements that are associated with the included content element types. FIG. 21 illustrates the result of associating content element types with specific content elements in order to build a multimedia presentation using a director template file 100. As shown, a first content element 113 consisting of an image of the words “French Fries” is displayed in the position reserved for the content element type named Item Name 110; a second content element 115 consisting of an image of a box of French Fries is displayed in the position reserved for the content element type named Item Photo 112; and a third content element 117 consisting of the text “$0.45” is displayed in the position reserved for the content element type named Item Price 114. The specific content elements displayed by the director template file may be changed by simply associating different content elements with the included content element types. Scheduling files 38 can be used to define which director template files 100 are to be played at given times.

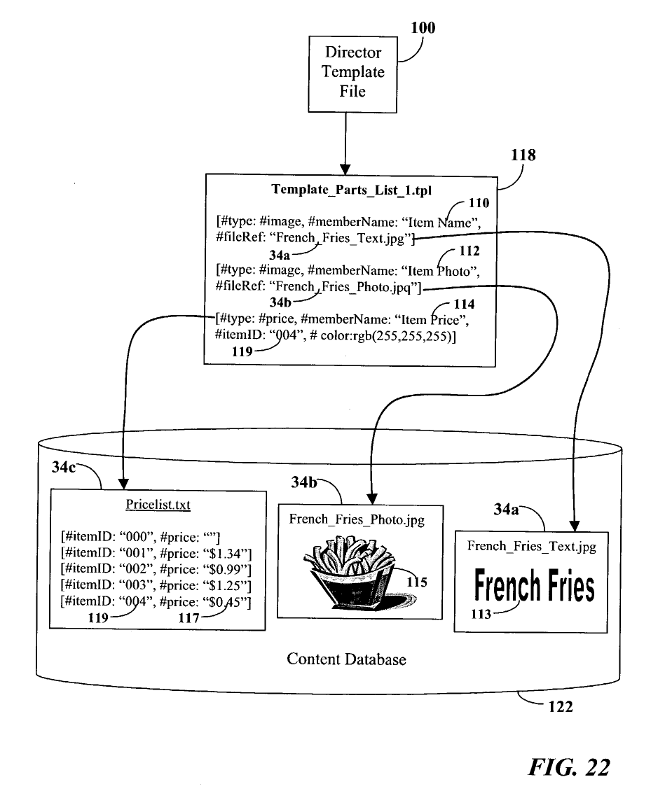

FIG. 22 is a graphical representation of the relationship between a director template file 100, a template parts list 118 and a content database 122, illustrating an exemplary method for associating content elements and content element types. A director template file 100 may include a pointer, link or other reference to a template parts list 118. The template parts list 118 is a text file that identifies associations between content element types and content elements. Content elements are contained in media content files 34 that may be stored in a content database 122 or other suitable storage location of a display system 12. The template parts list 118 thus also includes pointers, links or other references to the storage location(s) of the media content files 34.

In the example shown, the director template file 100 points to a template parts list 118 named Template_Parts_List_{—}1.tpl. The template parts list 118 identifies the content element type named Item Name 110 as being of the type #image and associated with a first content element 113 comprising an image of the words “French Fries,” which is contained in a first media content file 34a named French_Fries_Text.jpg. Similarly, the template parts list 118 identifies the content element type named Item Photo 112 as being of the type #image and associated with a second content element 115 comprising an image of a box of French Fries, which is contained in a second media content file 34b named French_Fries_Photot.jpg. The template parts list 118 also associates the content element type named Item Price 114 with a third content element 117 comprising the text “$0.45,” which is stored as item “004” 119 in a third media content file 34c named Pricelist.txt. The content element type Item Price is defined as being of the type #price. Logic may be provided, for example in the director template file 100, the template parts list 118 and/or the projector software 32 for associating the type #price with the media content file 34c named Pricelist.txt.

For the purpose of brevity, the exemplary director template file 100 and template parts list 118 are intentionally simplistic. In practice a presentation defined by a director template file 100 may include many content element types displayed at different times and positions. For example, in exemplary director template file 100, the content element type named Item Photo 112 may be displayed for several minutes and then replaced by a content element type named Item Photo_{—}2. In such an example, the corresponding template parts list 118 must include associations for the content element type named Item Photo 112 and the content element type named Item Photo_{—}2. Thus, a template parts list 118 should associate a content element with each content element type included in the corresponding director template file 100. The more complex the director template file 100, the lengthier the template parts list 118 will generally be.

Using a template parts list 118 to associate content element types with content elements provides several relatively simple options for modifying a presentation. As one option, a template parts list 118 may be altered so as to associate different content elements with the content element types defined in a director template file 100, thereby changing the content elements displayed in the presentation. As another option, the content elements themselves may be altered in order to change the presentation. For example, the exemplary media content file 34c named Pricelist.txt could be edited using an appropriate editing program in order to change the price of item “004” 119 from “$0.45” to “$0.50.” As yet another option, a presentation may be modified by linking the director template file 100 to a different template parts list 118, which associates the content element types with different content elements. This could be accomplished without the need to re-compile the director template file 100 by including logic in the template director file 100 that causes it to search for and select from available template parts lists 118. The option to associate the director template file 100 with different template parts lists 118 allows prior versions of a presentation to be preserved (since neither the content elements nor the prior template parts list are altered) and redisplayed if desired. Thus, the use of director template files 100 and template parts lists 118 allows a presentation to be changed without the need to debug and/or re-compile a multimedia presentation each time content elements are added, removed or modified.

Director template files 100 may be formatted using the common Director file format, “.dir”. As another option, director template files 100 may be formatted using a compressed file format, such as the “.dcr” file format. The “.dcr” file format is generated by compressing Director files using a software application known as “Afterburner,” which is marketed by Macromedia. “Afterburner” compresses Director files for playback in a network environment or from local drives. “Afterburner” is typically bundled with Director software and is typically accessible through Director's Xtras menu. Compression of director template files 100 allows for faster transmission rates across a network, as compared to standard .dir files.

Director template files 100, template parts lists 118 and media content files 34 may be stored at a distribution server 14 to await downloading by appropriate display systems 12. The distribution server 14 may provide a web-based interface, as described above, to allow content administrators 18 and display administrators 16 to manipulate director template files 100, template parts lists 118 and media content files 34. In certain embodiments of the invention, content administrators 18 may add, delete or modify presentations by simply logging-on to the distribution server 14 to add, delete or modify template parts lists 118 and media content files 34. Once a director template file 100 is downloaded to a display system 12, the presentation defined by that file may be modified by downloading substitute template parts lists 118 and any new media content files 34.

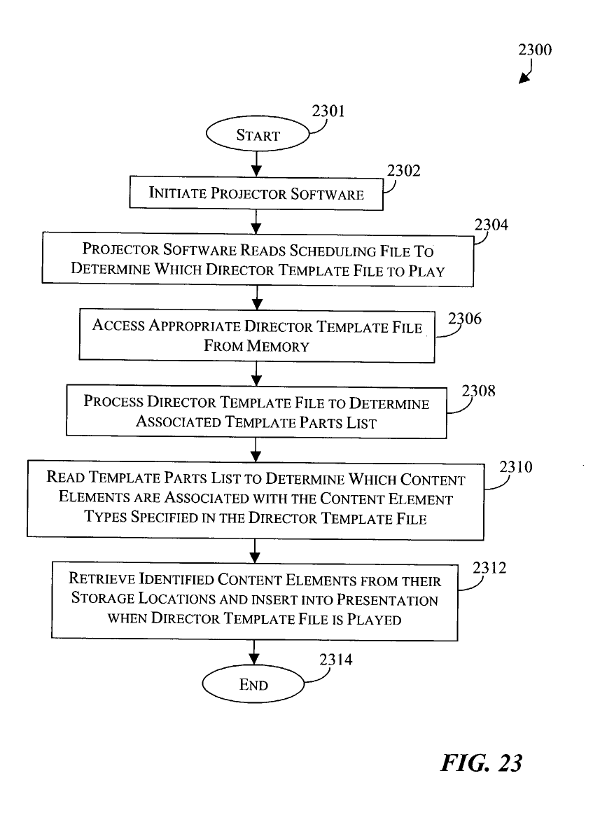

FIG. 23 is a flow chart illustrating exemplary processing used to display a multimedia presentation using director template files. The exemplary method 2300 begins at start step 2301 and progresses to step 2302, where the projector software 32 is initiated. Next at step 2304, the projector software reads a scheduling file 38 to determine which director template file 100 to play at the present time and at future times. The projector software 32 may use a function referred to as “FileIO Xtra” in order read the scheduling file 38. Other and/or additional functions for reading external files may be employed by the projector software 32.

After determining from the scheduling file 38 which director template file 100 to play first, the appropriate director template file 100 is accessed from memory at step 2306. At step 2308, the director template file 100 is processed to determine the associated template parts list 118. Again, the particular template parts list 118 associated with the director template file 100 may be specified in the template director file 100. Alternatively, the director template file 100 and/or projector software 32 may include logic for locating an available template parts list 118 that meets certain criteria. For example, such logic may dictate that a template parts list 118 (e.g., a “.tpl” file) residing in a particular directory is to be associated with the director template file 100. Or, if more than one template parts list 118 is available in a directory, creation dates of the template parts lists 118 may be compared to determine which one is the newest. Other methods for locating and selecting template parts lists 118 to be associated with a director template file 100 will occur to those of skill in the art. Default content elements can be designated in case a template parts list 118 cannot be accessed. Thus, instead of returning an error when a template parts list 118 cannot be located, the director template file 100 may access default content elements so as to display a default presentation when played by the projector software 32.

When the appropriate template parts list 118 is selected, it is read at step 2310 to determine which content elements are associated with the content element types specified in the director template file 100. The logic for reading the template parts list 118 may be included in the director template file 100 and/or projector software 32. Again, the function “FileIO Xtra” and/or any other suitable function for reading external files may be used to read the template parts list 118. The name of each content element and/or the name of the media content file 32 in which each content element is stored is identified by reading the template parts list 118. Next at step 2312, the identified content elements are retrieved from their storage locations and are inserted into the presentation when the director template file 100 is played by the projector software 32. The exemplary method then ends at step 2314.

Those skilled in the art will appreciate that director template files are but one example of the type of template files that may be used in accordance with the present invention. A template file may be any type of file that defines an arrangement and presentation of content element types and/or content elements. Other formats may be suitable for template parts lists as well. Where other types file formats are used for template files and template parts lists, projector software other than stub projectors may be necessary to build and display the multimedia presentations.

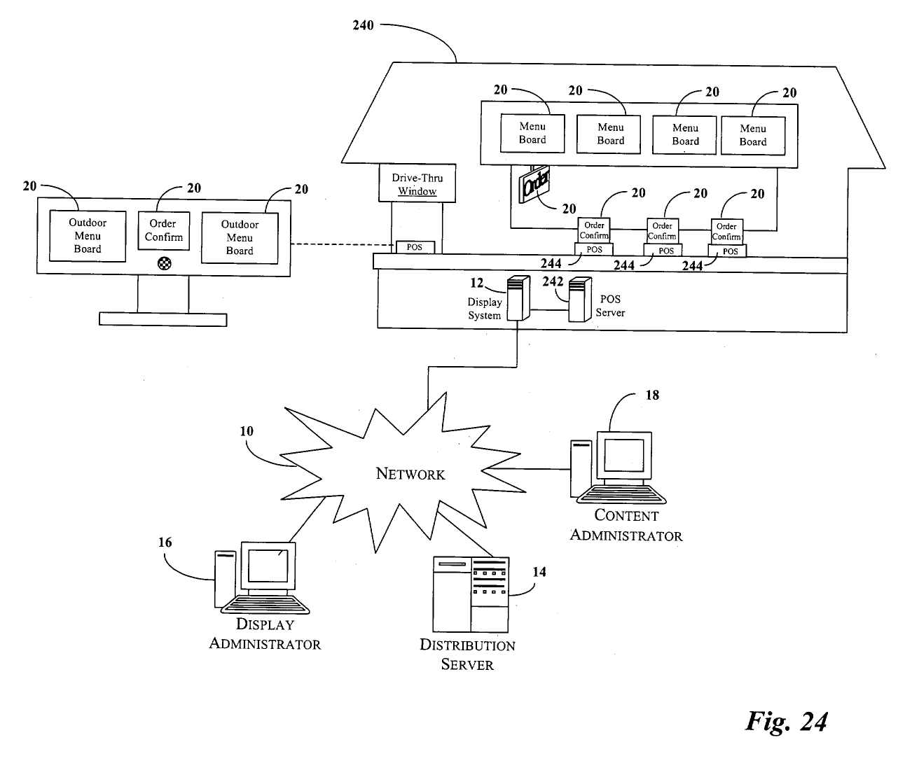

As previously mentioned, a display system 12 may drive multiple displays 20 with the same or different multimedia presentations through a suitable connection, for example a hard-wire or wireless connection. An exemplary embodiment of the present invention is implemented in a “fast-food” restaurant environment, which is shown by way of illustration in FIG. 24. As shown, a display system 12 may drive displays 20 that are used for a variety of purposes, including indoor and outdoor menu boards, indoor and outdoor order confirmation screens, etc. In addition, displays 20 may be used as order presentation screens present order information to the kitchen. These and other displays 20 may be driven by one or more display systems 12 resident in or in communication with the fast-food restaurant 240.

In this regard, display systems 12 according to the present invention may be used to control all multimedia presentations in a restaurant environment. Each display 20 in communication with the display system(s) 12 may present a different multimedia presentation. Each multimedia presentation may include any of a variety of media content, including static images, animated images or motion video, sound, color, etc. All multimedia presentations may controlled by a display administrator 16. Accordingly, the various multimedia presentations presented in the fast-food restaurant environment may be more efficiently changed and, therefore, better targeted to consumers.

A display system 12 can be integrated with a local server, such as a POS system. For example, a display system 12 may be configured for communication with a POS server 242, which in turn communicates with one or more POS devices 244. The POS server 242 gathers, stores and serves POS data, which may include such things as pricing data, transaction data and possibly inventory data. Transaction data is gathered from the POS devices 244 during consumer transactions. Optionally, transaction data may include certain demographic data concerning the consumer, such as approximate age, gender, nationality, etc. The operator of the POS device 244 may input such demographic data based on observation of the consumer, or may ask the consumer to provide certain information. A POS device 244 may also be implemented as a kiosk to operated by the consumer. For example, the kiosk may be provided as a consumer self-service option, allowing consumers to place orders and make payments therefore. In such a case, the consumer may elect to input certain demographic information to the kiosk POS device 244, available input devices, which may include touch screens, pointing devices, keyboards, microphones, imaging devices, etc. For the purposes of this discussion only, any demographic information stored at a POS server 242, will be referred to as POS data, along with any transaction data, inventory data and pricing data stored at the POS server 242.

In addition, kiosks that do not incorporate POS devices 244 may be implemented in the restaurant environment to provide information and/or entertainment to and to collect information from consumers. Such information may be provided by the kiosk to a POS server 242 and/or to another local server and/or to the display system 12. Examples of other local servers that may be integrated with a display system 12 in a fast-food restaurant environment include inventory tracking systems, supply chain management systems, etc.

A display system 12 may be configured to “push” or “pull” POS data from a POS server 242. The display system may be configured with logic to incorporate POS data into a multimedia presentation. By way of illustration, a display system 12 may access current pricing data from a POS server 242 may display such pricing information as part of a menu board presentation on a display 20. While prices for certain items offered by the restaurant may be static and thus incorporated into multimedia presentations by the content administrator 18, other prices may be changed at the restaurant depending on supply and demand as well as other factors. Thus, allowing the display system 12 to access the POS server 242 provides an automated method for allowing multimedia presentations to be modified to reflect most current pricing structures.

Configuring the display system 12 to communicate with a POS server 242 can provide other significant advantages as well. For example, the display system 12 may be configured with logic for adapting or creating a multimedia presentation tailored to a specific consumer or group of consumers based on collected transaction data and/or demographic data. Transaction data may be used by the display system 12 to provide order confirmation presentations on indoor and/or outdoor order confirmation displays 20. Cross-selling or up-selling presentations may also be rendered by the display system 12 based on determinations or assumptions in relation to inventory data, transaction data and/or demographic data, etc. The display system 12 and/or the POS server 242 may execute logic, such as script(s), application program(s), etc., for processing inventory data, transaction data and/or demographic data, etc. in order to make determinations or assumptions about additional products that a consumer may be interested to purchase.

A display system 12 may access POS data files stored at the POS server 242 or at another remote storage device. Alternatively or in addition, POS data files may be stored within a local memory storage of the display system 12. POS data files may be referenced by director files 36 in the same manner as any other external media content files 34. Based on the foregoing discussion of template director files 100 and template parts lists 118, it should be apparent that a template parts list 118 could be made to reference a POS data file, or any other media content file 34, stored at the display system 12, at the POS server 242 or elsewhere. Again, template parts lists 118 could be modified or substituted in order to reference updated POS data files without having to modify the associated template director file 100.

Those skilled in the art will appreciate that the fast-food restaurant environment is explained by way of example only, and that the present invention could be used in any environment where multiple multimedia presentations are presented on multiple displays 20. Other exemplary operating environments include, retail establishments, public transportation hubs (e.g., airports, bus stations, train stations, etc.), financial institutions, government agency offices (e.g., post offices, DMV offices, etc.), etc. Thus, as mentioned above, a POS system is but one example of a local server that may be integrated with a display system 12 of the present invention. Other types of local servers include, reservations systems, scheduling systems (e.g. for tracking arrival/departures of airplanes, buses, trains, etc.), security systems and general purpose web servers. Any data gathered by and stored at a local server may be referred to generally as “local data,” even if such data is received from external sources. Any type of local data may be easily integrated into a multimedia presentation presented by a display system 12 according to the above principles. Accordingly, the principles of the present invention should not be limited to implementation in a fast-food restaurant environment unless otherwise specified.

While one or more preferred embodiments of the invention have been described above, it should be understood that any and all equivalent realizations of the present invention are included within the scope and spirit thereof. Thus, the embodiments depicted are presented by way of example only and are not intended as limitations upon the present invention, and it should be understood by those of ordinary skill in this art that the present invention is not limited to these embodiments since modifications can be made. Therefore, it is contemplated that any and all such embodiments are included in the present invention as may fall within the literal or equivalent scope of the appended claims.

What is claimed is:

1. A method for facilitating the display of a template-based multimedia presentation on a display comprising:
creating a template file defining an arrangement and presentation of selected content element types within the multimedia presentation, wherein said template file is configured to reference a template parts list;
creating the template parts list that associates the selected content element types with corresponding content elements stored in media content files;
making said template file, said template parts list and said media content files available to a display system configured to drive one or more displays; and
at the display system, executing a stub projector configured to process the template file, wherein the template file references the template parts list in order to identify which of the content elements are associated with the selected content element types and to retrieve said identified content elements from the corresponding media content files in order to build the multimedia presentation for display on the one or more displays.

2. The method of claim 1, wherein the template file further defines the arrangement and presentation of selected content elements.

3. The method of claim 1, further comprising the steps of:
creating multiple template files, each referencing a corresponding template parts list;
creating a scheduling file indicating a schedule according to which the display system is to process selected ones of said template files in order to build corresponding multimedia presentations for display on selected ones of said displays;
making the scheduling file available to the display system; and
wherein the stub projector is configured to read the scheduling file to determine which of the template files to process according to the schedule.

4. The method of claim 3, wherein making said scheduling file available to the display system comprises downloading said scheduling file to the display system in response to determining that said scheduling file is more current than any previously downloaded scheduling files stored at said display system.

5. The method of claim 3, wherein the display system is in communication via a network with a distribution server storing an updated scheduling file indicating an updated schedule according to which the display system is to process selected ones of said template files;
wherein the display system communicates with said distribution server in order to request download of the updated scheduling file; and
wherein the stub projector reads the updated scheduling file to determine which of the template files to process according to the updated schedule.

6. The method of claim 1, further comprising the step of changing the multimedia presentation by modifying the template file to reference a different template parts list, said different template parts list associating said selected content element types with different content elements.

7. The method of claim 1, further comprising the step of changing the multimedia presentation by creating a new template file, said new template file defining a new arrangement and presentation of the selected content element types within the multimedia presentation and wherein said new template file is configured to reference said template parts list.

8. The method of claim 1, wherein the template file, said template parts list and said media content files are transmitted from a content administrator site to a distribution server via a network for storage; and
wherein the display system accesses the distribution server via the network in order to request download of the template file, said template parts list and said media content files.

9. The method of claim 8, wherein the distribution server stores the template file, said template parts list and said media content files in a directory associated with the display system.

10. The method of claim 8, wherein the content administrator site stores the template file, said template parts list and said media content files in a general directory of the distribution server;
wherein the distribution server further hosts multiple display system directories, each of said display system directories being associated with one of a plurality of display systems; and
wherein a display administrator having administrative authority over said display system communicates with the distribution server in order to designate the template file, said template parts list and said media content files for storage in a display system directory that is associated with said display system.

11. The method of claim 1, wherein making said template file, said template parts list and said media content files available to a display system comprises downloading one or more of the template file, said template parts list and said media content files to the display system in response to determining that one or more of the template file, said template parts list and said media content files has not been previously downloaded to said display system.

12. A method for facilitating the display of template-based multimedia presentations at a plurality of displays, comprising:
storing at a distribution server a plurality of template files, a plurality of template parts lists, a plurality of media content files storing media content elements, and a plurality of scheduling files, each template file defining an arrangement and presentation of selected content element types and being configured to reference a selected template parts list that associates the selected content element types with corresponding content elements, and each scheduling file indicating a schedule according to which a display system is to process selected ones of the template files;
upon request by a requesting display system, downloading to the requesting display system from the distribution server selected ones of the template files, the template parts lists and the media content files and a selected scheduling file;
at the requesting display system, executing a stub projector file configured to read the selected scheduling file to determine which of the selected template files to process according to the schedule; and
wherein processing a downloaded template file causes the downloaded template file to reference a downloaded template parts list in order to identify which of the content elements are associated with the selected content element types and to retrieve said identified content elements from the corresponding media content files in order to build the multimedia presentation for display on the one or more displays.

13. The method of claim 12, wherein each template file further defines the arrangement and presentation of selected content elements.

14. The method of claim 12, wherein the selected scheduling file is downloaded to the requesting display system in response to determining that the selected scheduling file is more current than any previously downloaded scheduling files stored at said requesting display system.

15. The method of claim 12, wherein the selected ones of the template files, the template parts list and the media content files are downloaded to the requesting display system in response to determining that one or more of the template file, said template parts list and said media content files has not been previously downloaded to said requesting display system.

16. The method of claim 12, further comprising the step of changing the multimedia presentation by modifying the template file to reference a different template parts list, said different template parts list associating said selected content element types with different content elements.

17. The method of claim 12, further comprising the step of changing the multimedia presentation by creating a new template file, said new template file defining a new arrangement and presentation of the selected content element types within the multimedia presentation and wherein said new template file is configured to reference said template parts list.

18. The method of claim 12, wherein the plurality of template files, template parts lists, media content files and scheduling files are transmitted from a content administrator site to the distribution server via a network for storage.

19. The method of claim 18, wherein the plurality of template file, template parts lists and media content files are stored at the distribution server in a directory associated with the requesting display system.

20. The method of claim 18, wherein the plurality of template files, template parts lists and media content files are stored in a general directory of the distribution server;
wherein the distribution server further hosts multiple display system directories, each of said display system directories being associated with one of the plurality of display systems; and
wherein a display administrator having administrative authority over said requesting display system communicates with the distribution server in order to designate the selected ones of the template file, said template parts lists and said media content files and said selected scheduling file for storage in a display system directory that is associated with said requesting display system.

21. A system for facilitating the display of template-based multimedia presentations at a plurality of displays comprising:
a network communication device for receiving from a content administrator via a network a plurality of template files, a plurality of template parts lists, a plurality of media content files storing media content elements, and a plurality of scheduling files, each template file defining an arrangement and presentation of selected content element types and being configured to reference a selected template parts list that associates the selected content element types with corresponding content elements, and each scheduling file indicating a schedule according to which a display system is to process selected ones of the template files;
a memory storage for storing said template files, said template parts lists, said media content files and said scheduling files;
a processor for executing computer executable instructions for responding to a download request from a requesting display system by transmitting requested ones of said template files, said template parts lists and said media content files and a requested scheduling file;
wherein said requesting display system executes projector software for reading the requested scheduling file to determine which of the requested template files to process according to the schedule; and
wherein processing a downloaded template file causes the downloaded template file to reference a downloaded template parts list in order to identify which of the content elements are associated with the selected content element types and to retrieve said identified content elements from the corresponding media content files in order to build the multimedia presentation for display on one or more displays.

22. The system according to claim 21, wherein said template files, said template parts lists, said media content files and said scheduling files are logically stored in a directory of said memory storage; and
wherein said processor executes further computer executable instructions for authenticating said requesting display system for access to the directory prior to responding to the download request.

23. The system according to claim 22, wherein transmitting the requested ones of said template files, said template parts lists, said media content files and said scheduling files to said requesting display system comprises mirroring the directory at the requesting display system.

24. The system according to claim 22, wherein the directory is identified by a directory identifier; and
wherein authenticating said requesting display system comprises determining that a display system identifier received from said requesting display system matches the directory identifier.

25. The system according to claim 21, wherein said template files, said template parts lists, said media content files and said scheduling files are logically stored in a first directory of said memory storage; and
wherein links to said requested template files, template parts lists, media content files and scheduling files are logically stored in a second directory of said memory storage, said second directory being associated with said requesting display system.

26. The system according to claim 21, wherein the download request includes a request to download said requested scheduling file and is made by said requesting display system in response to determining that said requested scheduling file is more current than any previously downloaded scheduling files stored at said requesting display system.

27. The system according to claim 21, wherein said download request includes a request to download one or more of said requested template files, said requested template parts lists, and said requested media content files and is made by said display system in response to determining that said one or more requested template files, requested template parts lists and requested media content files has not been previously downloaded to said display system.

28. The system according to claim 21, wherein said projector software comprises a stub projector file.
